(19) United States
(12) Patent Application Publication
(10) Pub. No.: US 2013/0113840 A1
(43) Pub. Date: May 9, 2013

(54) Method for Panel Color Calibration and Associated Color Calibration System

(71) Applicants: Te-Wei Hsu, New Taipei City (TW); Tung-Han Sung, New Taipei City (TW); Chuan-Tsung Chen, Taoyuan Hsien (TW)

(72) Inventors: Te-Wei Hsu, New Taipei City (TW); Tung-Han Sung, New Taipei City (TW); Chuan-Tsung Chen, Taoyuan Hsien (TW)

(73) Assignee: MStar Semiconductor, Inc., Chupei (TW)

(21) Appl. No.: 13/400,037

(22) Filed: Feb. 18, 2012

(30) Foreign Application Priority Data
Nov. 7, 2011 (TW) 100140529

(51) Int. Cl. G09G 5/10

(52) U.S. Cl. 345/690

(57) ABSTRACT

A method for panel color calibration for corresponding a source input to a calibrated input is provided. From color components of the calibrated input, a primary calibrated component and secondary calibrated components are selected to perform a color characteristic value fitting for the calibrated input. In the color characteristic value fitting, the primary calibrated component is kept unchanged and the secondary calibrated components are adjusted, such that a color characteristic value of the calibrated input matches a target characteristic value. A luma comparison is next performed to determine whether a luma corresponding to the calibrated input obtained from the color characteristic value fitting matches a target luma. When a result from the luma comparison is negative, the primary calibrated component of the calibrated input is updated, and the color characteristic value fitting and the luma comparison are iterated accordingly.

### CROSS-REFERENCE TO RELATED APPLICATION

This application claims the benefit of Taiwan Patent Application Serial No. 100140529, filed Nov. 7, 2011, the entirety of which is incorporated herein by reference.

### BACKGROUND

1. Technical Field

The present disclosure relates in general to a method for panel color calibration and an associated color calibration system, and more particularly, to a method for panel color calibration and an associated color calibration system capable of attending to both luma tracking and color tracking.

2. Description of the Related Art

Display panels, capable of presenting multicolor static/dynamic images, are prevalent in the modern information society. When displaying an image, an image source provides an input (i.e., a source input) corresponding to each pixel on the panel, so that the pixel displays colors according to the input. For example, a source input may be represented as (Ri, Gi, Bi), where Ri, Gi and Bi respectively represent red, green and blue components (i.e., source components).

However, color responses at different panels may be noticeably inconsistent as a result of inevitable minute differences in a manufacturing process of the panels. That is, colors presented by different panels nevertheless differ although same inputs are provided to the panels. In order to render consistent color responses for different panels, or to have color responses of different panels meet required standards, panels undergo a color calibration process before shipping out of the factory. A common approach for color calibration is to map a source input (Ri, Gi, Bi) to a calibrated input (Ra, Ga, Ba) before being provided to a panel, so that the panel receives the calibrated input (Ra, Ga, Ba) yet displays colors according to the source input, wherein Ra, Ga and Ba respectively represent red, green and blue components (i.e., calibrated components) of the calibrated input. For different panels, a same source input may be mapped to different calibrated inputs due to different display characteristics of the panels, and thereby colors displayed by different panels meet required standards or appear consistent. In short, panel color calibration is a technique that provides corresponding calibrated inputs for source inputs based on panel characteristics.

A color displayed by a panel may be measured and quantitatively described as a display value (X, Y, Z). For example, X, Y and Z respectively represent a coordinate component (i.e., a display component) in an XYZ color space. The display component Y alone represents luma (sometimes referred to as luminance) of the color, and a color temperature corresponding to the color may be obtained with the display components X, Y and Z. That is to say, through color display with the calibrated input (Ra, Ga, Ba) on a panel, the source input (Ri, Gi, Bi) is responded to a corresponding display value (X, Y, Z), and the corresponding luma and color temperature can be obtained according to the display value (X, Y, Z).

To achieve panel color calibration that provides consistent color performance for different panels and to obtain a most accurate calibration result when performing color calibration on a panel, two color-associated parameters need to be considered. One of the parameters is the color temperature. After undergoing color calibration, color temperatures responded by a panel of source inputs having different grayscales should approximate corresponding target color temperatures, respectively. That is to say, when the source input (Ri, Gi, Bi)=(V, V, V), presenting a grayscale of a value V, a corresponding color temperature CCT should match a target color temperature CCTtarget. The value V may vary between a minimum value Vmin and a maximum value Vmax, i.e., the value V may be smaller than or equal to the maximum value Vmax and be greater than or equal to the minimum value Vmin. For example, the minimum value Vmin and the maximum value Vmax are respectively 0 and 255.

The other crucial parameter for panel color calibration is luma. More specifically, after undergoing color calibration, luma responded by a panel of source inputs having different grayscales should substantially match a theoretical gamma curve. That is to say, when the source input (R, Gi, Bi)=(V, V, V), a luma WY responded at the panel from a corresponding calibrated input should satisfy a formula WY=Ymax*((V/Vmax))̂(2.2), where Ymax is a constant associated with panel color responses, and the value V varies between the minimum value Vmin and the maximum value Vmax. In other words, when the source components Ri, Gi and Bi of the source input (Ri, Gi, Bi) all equal the value V, representing a grayscale (V, V, V), the luma WY responded after undergoing panel color calibration should be directly proportional to the value V to the power 2.2.

In many conventional panel color calibration techniques, precisions in the two parameters of color temperature and luma cannot be attended to at the same time. For example, certain conventional panel color calibration techniques are capable of matching color temperatures displayed by a panel to target color temperatures, but fail in rendering luma that match the theoretical gamma curve for different grayscales. In contrast, although other conventional techniques success in achieving luma that match the theoretical gamma curve for different grayscales, corresponding color temperatures yet fall short in meeting target color temperatures.

### SUMMARY

It is an objective of the present disclosure to provide a method for panel color calibration, which is capable of attending to precisions for both color temperature and luma to provide a calibrated input (Ra, Ga, Ba) corresponding to a source input (Ri, Gi, Bi) of a panel. A first input (Rp, Gp, Bp) comprises a plurality of first input components Rp, Gp and Bp, which are respectively red, green and blue first input components. The method comprises a number of steps. The source input is utilized as the first input, and one from a plurality of first input components (e.g., red, green and blue first input components) is selected as a primary calibrated component, while the other two first input components serve as secondary calibrated components. A color characteristic value fitting is performed on the first input. In the color characteristic value fitting, with the primary calibrated component kept unchanged, the secondary calibrated components are adjusted to update the first input as a first updated value, so that a relationship between a color characteristic value CCT corresponding to the first updated value and a target characteristic value CCTtarget satisfies a first predetermined condition (e.g., a difference between the two is smaller than a first predetermined value). In a next luma comparison, it is compared and determined whether a relationship between a luma WY corresponding to the first updated data obtained from the color characteristic value fitting and a target luma WYtarget satisfies a second predetermined condition (e.g., a difference between the two is smaller than a second predetermined value). When a result from the luma comparison is negative, the primary calibrated component in the first updated value is updated, and the current first updated value is utilized as the first input. The color characteristic value fitting and the luma comparison are iterated based on the first input from the first updated value, until the luma WY corresponding to the first updated value matches the target luma WYtarget (the two satisfy the second predetermined condition). At this point, the first updated value serves as the calibrated input. When the luma WY matches the target luma WYtarget, since the color characteristic value CCT matches the target characteristic value CCTtarget in the color characteristic value fitting (the two satisfy the first predetermined condition), the calibrated input provided by the present disclosure is capable of meeting both luma and color requirements of the panel color calibration.

The panel responds a red first input component monochromatic input (Rp, 0, 0)=(rp, 0, 0) to a corresponding red monochromatic luma RY(rp), a green first input component monochromatic input (0, Gp, 0)=(0, gp, 0) to a corresponding green monochromatic luma GY(gp), and a blue first input component monochromatic input (0, 0, Bp)=(0, 0, bp) to a corresponding blue monochromatic luma BY(bp). For the red first input component, the monochromatic lumas RY(rp) from different values of rp are compared, and a red monochromatic luma RY(rp) corresponding to a largest value is selected as a red reference monochromatic luma Yr_m. Similarly, for green first input component, the monochromatic lumas GY(gp) from different values of gp are compared, and a green monochromatic luma GY(gp) corresponding to a largest value is selected as a green reference monochromatic luma Yg_m; for blue first input component, the monochromatic lumas BY(bp) from different values of by are compared, and a blue monochromatic luma BY(bp) corresponding to a largest value is selected as a blue reference monochromatic luma Yb_m. Red, green and blue standard monochromatic lumas Yr_t, Yg_t and Yb_t are respectively obtained according to the target characteristic value CCTtarget.

In an embodiment of the present disclosure, a standard monochromatic luma Yc_t and a reference monochromatic Yc_m corresponding to the first input components are compared to accordingly select the primary calibrated component.

For example, to select the primary calibrated component, the reference monochromatic luma Yc_m is divided by the standard monochromatic luma Yc_t of the first input component to obtain a gain A_c=Yc_m/Yc_t (where c represents one of r, g and b). Three gains A_r, A_g and A_b corresponding to the first input components are compared to one another, and the first input component corresponding to the smallest gain is selected as the primary calibrated component. For example, assuming the red gain A_r corresponding to the red first input component is the smallest (smaller than the green gain A_g and the blue gain A_b), the red first input component selected as the primary calibrated component, and the green and blue first components are then the secondary calibrated components.

In an embodiment of the present disclosure, the primary calibrated component of the first input may equal a maximum value Vmax, and the color characteristic value fitting is performed to obtain a top calibrated input (Rp_top, Gp_top, Bp_top) corresponding to a top luma Ymax. According to the top luma Ymax and a predetermined gamma value 2.2, as well as a formula WYtarget(V)=Ymax*((V/Vmax))̂2.2, a reference curve is obtained to associate a value V to a corresponding target luma WYtarget(V), and also to associate the maximum value Vmax to the top luma Ymax by the reference curve. To perform the luma comparison of the method of the present disclosure for a grayscale source input (Ri, Gi, Bi)=(V, V, V) in the value V, the target luma WYtarget(V) may be determined according to the value V and the reference curve.

It is another objective of the present disclosure to provide a color calibration system, which is applied to a panel to provide a calibrated input corresponding to a source input of the panel. The color calibration system comprises a primary calibrated component selecting module, a color characteristic value fitting module, a luma comparing module and a primary calibrated component setting module. From a plurality of first input components, the primary calibrated component selecting module selects one first input component as a primary calibrated component while the other first input components are secondary calibrated components. The color characteristic value fitting module, being coupled to the primary calibrated component selecting module, performs a color characteristic value fitting. In the color characteristic value fitting, with the primary calibrated component kept unchanged, the secondary calibrated components are adjusted to update the first input as a first updated value, such that a relationship between a color characteristic value corresponding to the first updated value and a target characteristic value satisfies a first predetermined condition.

The luma comparing module, being coupled to the color characteristic value fitting module, performs a luma comparison. In the luma comparison, it is compared and determined whether a relationship between the luma corresponding to the first updated value obtained from the color characteristic value fitting and a target luma satisfies a second predetermined condition to provide a corresponding luma comparison result. The primary calibrated component setting module is coupled to the luma comparing module. When the luma comparison result is negative, the primary calibrated component setting module updates the primary calibrated component of the first updated value, and utilizes the current first updated value as the first input. The color characteristic value fitting module and the luma comparing module then respectively iterate the color characteristic value fitting and the luma comparison.

The above and other aspects of the present disclosure will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a controller performing panel color calibration on a panel according to an embodiment of the present disclosure.

FIG. 2 is a flowchart of a method according to an embodiment of the present disclosure.

FIG. 3 shows equations associated with the flowchart in FIG. 2.

FIGS. 4 and 5 illustrate some steps in the flowchart in FIG. 2.

FIG. 6 is a color calibration system according to an embodiment of the present disclosure.

### DETAILED DESCRIPTION

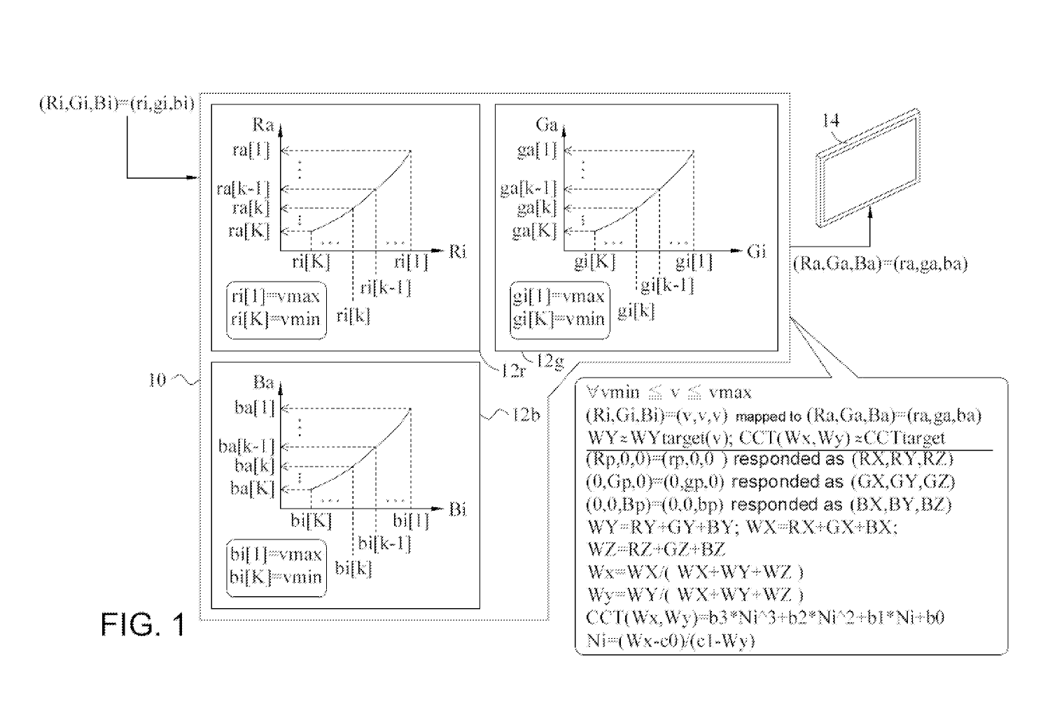

FIG. 1 is a schematic diagram of a controller 10 performing panel color calibration on a panel 14 according to an embodiment of the present disclosure. For example, the panel 14 is a liquid-crystal display (LCD), and the controller 10 is a controller integrated circuit (IC). To cope with color display characteristics of the panel 14, the present disclosure performs a test analysis on the panel 14 with a color testing apparatus before the panel 14 is shipped out of the factory, and a corresponding color calibration on the panel 14 based on obtained results. According to the method for panel color calibration of the present disclosure, the controller 10 in the panel 14 receives a source input (Ri, Gi, Bi) and provides a corresponding calibrated input (Ra, Ga, Ba) to the panel 14, which then displays colors according to the calibrated input (Ra, Ga, Ba). Based on calibration results, the controller 10 is recorded with three mapping tables 12r, 12g and 12b for red, green and blue color channels, respectively. The mapping table 12r maps a red source component Ri to a corresponding red calibrated component Ra; the mapping table 12g maps a green source component Gi to a corresponding green calibrated component Ga; the mapping table 12b maps a blue source component Bi to a corresponding blue calibrated component Ba.

A value of the red source component Ri of the received source input may be divided into K levels between a minimum value Vmin and a maximum value Vmax, i.e., between ri[1] and ri[K]. For example, K equals 256, and ri[k]=(256-k), where k=1 to 256. Corresponding to the values ri[1] to ri[K] in the K levels of the red source component Ri, the red calibrated component Ra in the mapping table 12r may also have K levels ranging between values ra[1] to ra[k]. Similarly, the green source component Gi may also be divided into K levels ranging from gi[1] to gi[K] between the minimum value Vmin and the maximum value Vmax, so that the mapping table 12g correspondingly provides K levels of values ranging from values ga[1] to ga[k] as the green calibrated component Ga. The blue source component Bi may also be divided into K levels ranging from bi[1] to bi[K] between the minimum value Vmin and the maximum value Vmax, so that the mapping table 12b correspondingly provides K levels of values ranging from ba[1] to ba[k] as the blue calibrated component Ba.

In other words, for the source input (Ri, Gi, Bi)=(ri[k1], gi[k2], bi[k3]), the controller 10 correspondingly provides the calibrated input (Ra, Ga, Ba)=(ra[k1], ga[k2], ba[k3]) constructed by the present disclosure to the panel 14, where k1, k2 and k3 may be equaled or different.

To render consistent color display responses of different panels, color calibration results of a grayscale source input are taken as evaluation criteria in the panel color calibration. When the source input (Ri, Gi, Bi)=(V, V, V), representing the grayscale of the value V, the controller 10 substitutes the value V into the mapping tables 12r, 12g and 12b to obtain the corresponding values of ra, ga and ba, and synthesizes the values into the calibrated input (Ra, Ga, Ba)=(ra, ga, ba). Through color display of the panel 14, the grayscale source input of the value V is responded to a white luma WY and a color characteristic value CCT(Wx, WY) with the calibrated input (Ra, Ga, Ba)=(ra, ga, ba). Thus, on the panel 14, the white luma WY provided by the panel color calibration technique of the present disclosure matches a target luma WYtarget, and the color characteristic value CCT(Wx, Wy) also matches a target characteristic value CCTtarget, as shown in FIG. 1.

According to this embodiment of the present disclosure, the color characteristic value CCT(Wx, Wy) may be a color temperature, and the target characteristic value CCTtarget may be a target color temperature. For example, the target color temperature CCTtarget is 5800, 6500 or 9300 degrees Kelvin. The target luma WYtarget(V) is a function associated with the value V, e.g., WYtarget(V)=Ymax*((V/Vmax)̂2.2), where Ymax is a constant associated with panel characteristics.

Also referring to FIG. 1, for a random calibrated input (Ra, Ga, Ba)=(ra, ga, ba), the luma WY and the color characteristic value CCT(Wx, Wy) responded by the panel 14 may be obtained through the descriptions below. Via color responses of the panel 14, a red monochromatic input (Rp, 0, 0)=(rp, 0, 0) corresponds to a red monochromatic display value (RX, RY, RZ), a green monochromatic input (0, Gp, 0)=(0, gp, 0) corresponds to a green monochromatic display value (GX, GY, GZ), and a blue monochromatic input (0, 0, Bp)=(0, 0, bp) corresponds to a blue monochromatic display value (BX, BY, BZ). The monochromatic display components RY, GY and BY respectively included in the red, green and blue monochromatic display values are respectively monochromatic lumas of red, green and blue. The white luma WY may be obtained through the monochromatic display components (monochromatic lumas) RY, GY and BY, e.g., the white luma WY=RY+GY+BY. Similarly, a white display component WX may be obtained through monochromatic display components RX, GX and BX, and another white display component WZ may be obtained through monochromatic display components RZ, GZ and BZ, as the equations shown in FIG. 1. According to the display components WX, WY and WZ, another two display components Wx and Wy can be derived−Wx=WX/(WX+WY+WZ) and Wy=WY/(WX+WY+WZ). With the display components Wx and Wy, a value Ni=(Wx−c0)/(c1−Wy) is further obtained. With the value Ni and the associated equation, a color characteristic value CCT(Wx, Wy)=b3*niA3+B2*NiA2+b1*Ni+b0 is obtained. The values c0 and c1 are constants, which may respectively be 0.332 and 0.1858; the values b3, b2, b1 and b0 are also constants, which may respectively be 437, 3601, 6831 and 5517.

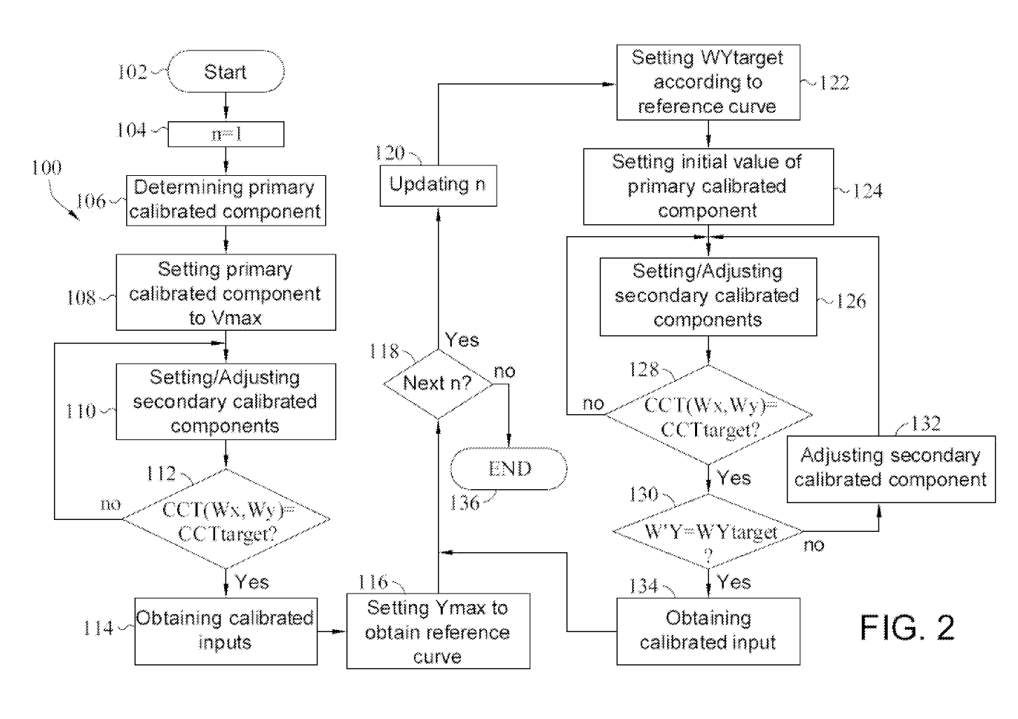

FIG. 2 shows a flowchart of a process 100 for establishing the mapping tables 12r, 12g and 12b for the use of panel color calibration on the panel 14 according to an embodiment of the present disclosure. The process 100 comprises steps below.

In Step 102, the flow 100 begins. For N (i.e., N number of) red source components ri[1] to ri[N], N green source components gi[1] to gi[N] and N blue source components bi[1] to bi[N], the flow 100 respectively provides N red calibrated components ra[1] to ra[N], N green calibrated components ga[1] to ga[N] and N blue calibrated components ba[1] to ba[N] for establishing the mapping tables 12r, 12g and 12b, where the number N may equal or differ from the level K of the color source components (in FIG. 1). For example, the number N is smaller than the level K. c is one of r, g and b, and the value of the source components ci[1] to ci[N] may be decremental. That is, for n=2 to N, the source component ci[n−1]>ci[n]. Further, the value of the source component ci[1] may be equal to the maximum value Vmax, and the source component ci[N] may equal the minimum value Vmin. The target characteristic value CCTtarget may also be set as the process 100 begins.

In Step 104, n is set to 1 to respectively provide calibrated components rp[1], gp[1] and bp[1] corresponding to the source components ri[1], gi[1] and bi[1]. Values of the source components ri[1], gi[1] and bi[1] may equal the maximum value Vmax.

In Step 106, a first input (Rp, Gp, Bp) is defined. The first input (Rp, Gp, Bp) includes a plurality of first input components Rp, Gp and Bp, which are respectively red, green and blue first input components. The source input is utilized as the first input, and one of the red, green and blue first input components is selected as a primary calibrated component while the remaining two first input components are secondary calibrated components. In an embodiment of the present disclosure, each maximum monochromatic luma supported by the panel 14 is identified for the monochromatic inputs of each color to serve as a reference monochromatic luma Yc_m, where c may be one of r, g and b. Further, according to the target characteristic value CCTtarget, red, green and blue standard monochromatic lumas Yr_t, Yg_t and Yb_t are respectively obtained. By dividing the reference monochromatic luma Yc_m by the standard monochromatic lumas Yc_t corresponding to the first input component, a gain A_c is obtained, i.e., A_c=Yc_m/Yc_t (where c represents one of r, g and b). The gains A_r, A_g and A_b corresponding to the first input components are compared to one another, and the first input component corresponding to the smallest gain is selected as the primary calibrated component. For example, assuming the gain A_r corresponding to the red first input component is the smallest (smaller than the gains A_g and A_b corresponding to the green first input component and the blue first input component), the red first input component is regarded as the primary calibrated component, while the remaining green first input component and the blue first input component are regarded as the secondary calibrated components.

The panel 14 responds the red first input component monochromatic input (Rp, 0, 0)=(rp, 0, 0) to a corresponding red monochromatic luma RY(rp), the green first input component monochromatic input (0, Gp, 0)=(0, gp, 0) to a corresponding green monochromatic luma GY(gp), and the blue first input component monochromatic input (0, 0, Bp)=(0, 0, bp) to a corresponding blue monochromatic luma BY(bp). For the first red input component, red monochromatic lumas RY(rp) corresponding to different values of rp are compared to one another, and the red monochromatic luma with a largest value is selected as the red reference monochromatic luma Yr_m. That is to say, assume that the red monochromatic luma RY(rp_m) corresponding to a particular value rp_m is greater than other red monochromatic lumas RY(rp) corresponding to all other values of rp, the red monochromatic luma RY(rp_m) is the red reference monochromatic luma Yr_m, and the value rp_m is the red reference monochromatic component. Similarly, a corresponding blue reference monochromatic luma Yb_m (corresponding to a blue reference monochromatic component bp_m) is selected for the blue first input component, and a corresponding green reference monochromatic luma Yg_m (corresponding to a green reference monochromatic component gp_m) is selected for the green first input component.

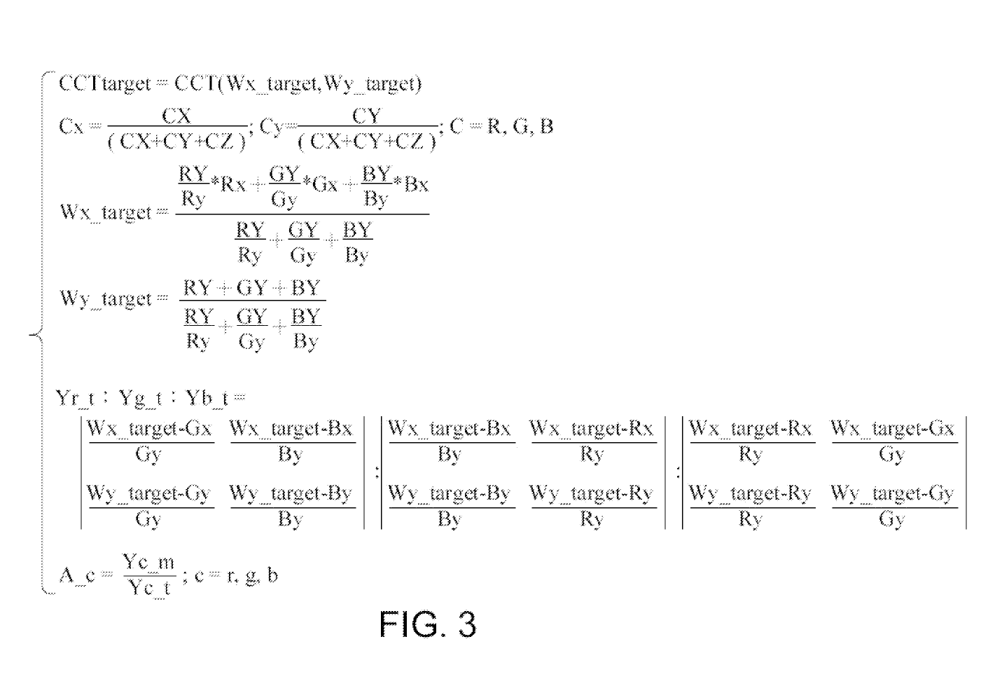

Equations for obtaining red, green and blue standard monochromatic luma Yr_t, Yg_t and Yb_t according to the target characteristic value CCTtarget are shown in FIG. 3. As previously stated, the color characteristic value CCT may be obtained from the two display components Wx and Wy, and hence the target characteristic value are also associated with the two target display components Wx_target and Wy_target, i.e., CCTtarget=CCT(Wx_target, Wy_target). As shown in FIG. 3, from the display components CX, CY, CZ, Cx and Cy (C represents one of R, G and B) responded from the target display components Wx_target and Wy_target by the panel 14, a ratio Yr_t:Yg_t:Yb_t of the red, green and blue standard monochromatic lumas may be calculated.

Being calculated from the target characteristic value CCTtarget, the ratio Yr_t:Yg_t:Yb_t of the standard monochromatic lumas can be interpreted as an ideal ratio for achieving the target characteristic value CCTtarget. That is, considering a particular first input (Rp, Gp, Bp) synthesized from the red, green and blue monochromatic inputs (Rp, 0, 0)=(rp, 0, 0), (0, Gp, 0)=(0, gp, 0), and (0, 0, Bp)=(0, 0, bp), when the red, green and blue monochromatic lumas RY, GY and BY respectively responded from the three monochromatic inputs by the panel 14 satisfy RY:GY:BY=Yr_t:Yg_t:Yb_t, it infers that the first input (Rp, Gp, Bp) is capable of rendering the target temperature CCTtarget for panel color display.

However, a ratio Yr_m:Yg_m:Yb_m of the red, green and blue reference monochromatic lumas may not equal to the ratio Yr_t:Yg_t:Yb_t of the red, green and blue standard monochromatic lumas. Such situation signifies that although largest values of the red, green and blue monochromatic lumas RY, GY and BY may be rendered by a particular first calibrated input, the color characteristic value CCT corresponding to the particular first input may not match the target characteristic value CCTtarget. On the other hand, a smallest gain corresponding to a particular first input component indicates the reference monochromatic luma Yc_m of the first input component is the closest to the standard monochromatic luma Yc_t (where c represents one of r, g and b) among the three reference monochromatic lumas of the first input components. Hence, the corresponding monochromatic luma may be changed (e.g., lowered) to approximate the standard monochromatic luma by adjusting the first input component in a small range (e.g., a small reduction). In other words, the particular first input component is the largest among the three first input components, and is thus selected as the primary calibrated component.

For example, assuming that the gain A_r corresponding to the red first input component is the smallest and is thus selected as the primary calibrated component, the red, green and blue standard monochromatic lumas are all multiplied by the gain A_r to obtain a ratio Ar*Yr_t:Ar_Yg_t:Ar_Yb_t. Regarding the red standard monochromatic luma, the product A_r*Yr_t equals the reference monochromatic luma Yr_m. However, regarding the green and blue standard monochromatic lumas, the products Ar*Yg_t and Ar*Yb_t are respectively smaller than the green and blue reference monochromatic lumas Yg_m and Yb_m, which implies there are still margins in the green and blue reference monochromatic lumas for adjusting the color temperature. Therefore, the green first input component and the blue first input component may serve as two secondary calibrated components, which are parameters for fitting to the target characteristic value CCTtarget.

In another embodiment, various algorithms for white balance may also be utilized for selecting the primary calibrated component.

In Step 108, the value of the primary calibrated component is set to the maximum value Vmax.

In Step 110, the secondary calibrated components are set/adjusted. When Step 110 is performed following Step 108, initial values of the two secondary calibrated components are respectively set. When Step 110 is iterated following Step 112, the secondary calibrated components are adjusted with the primary calibrated component remaining unchanged to further update the calibrated input synthesized from the three calibrated components. For example, at least one of the two secondary calibrated components is increased or decreased.

In Step 112, as the first input components rp[1], gp[1] and bp[1] are updated to synthesize a first updated value, it is determined whether a color characteristic value CCT corresponding to the first updated value matches a target characteristic value CCTtarget. According to the equations in FIG. 3, the display components Wx and Wy and the color characteristic value CCT(Wx, Wy) responded from the set first input components rp[1], gp[1] and bp[1] by the panel 14 may be obtained, and it is compared whether the color characteristic value CCT(Wx, Wy) matches the target characteristic value CCTtarget. For example, it is compared and determined whether a relationship between the color characteristic value CCT and the target characteristic value CCTtarget satisfies a first predetermined condition (e.g., a difference between the two is lower than a predetermined value). Step 114 is performed when the first predetermined condition is satisfied, or else the process 100 iterates Step 110.

Steps 110 and 112 are together regarded as a color characteristic value fitting, which updates the first input by adjusting the two secondary calibrated components without changing the primary calibrated component, until the color characteristic value CCT(Wx, Wy) corresponding to the updated first input matches the target characteristic value CCTtarget (i.e., the first predetermined condition is satisfied). This updated first input then serves as the first updated value. For example, assuming that the primary calibrated component is the red first input component, when Step 110 is iterated, the value of rp[1] is fixed at the maximum value Vmax while the green and blue first input components gp[1] and bg[ ]1 are adjusted and updated, until the color temperature CCT(Wx, Wy) corresponding to the first input (Rp, Gp, Bp)=(rp[1], gp[1], bp[1]) matches the target characteristic value CCTtarget. That is to say, the color temperature CCT(Wx, Wy) corresponding to the first updated value (Ru, Gu, Bu)=(ru[1], gu[1], bu[1]) should match the target characteristic value CCTtarget, where ru[1], gu[1] and bu[1] are respectively red, green and blue first updated components.

In Step 114, the red, green and blue first updated components ru[1], gu[1] and bu[1] are respectively provided for the red, green and blue source components ri[1], gi[1] and bi[1].

The first updated value (Ru, Gu, Bu)=(ru[1], gu[1], bu[1]) obtained from Step 114 corresponds to a source input with a largest grayscale (Ri, Gi, Bi)=(ri[1], gi[1], bi[1])=(Vmax, Vmax, Vmax) (Step 104), and at least one of the red, green and blue first updated components ru[1], gu[1] and bu[1] equals the maximum value Vmax (Step 108). Therefore, the first updated value (Ru, Gu, Bu)=(ru[1], gu[1], bu[1]) may be regarded as a top calibrated input (Rp_top, Gp_top, Bp_top), which is responded to a white display value (W′X(Vmax), W′Y(Vmax), W′Z(Vmax)) at the panel 14. The white luma W′Y represented by the display component W′X(Vmax) may serve as a top luma Ymax. At this point, the first updated value serves as the calibrated input (Ra, Ga, Ba)=(ra[1], ga[1], ba[1]) corresponding to the source input (Ri, Gi, Bi)=(ri[1], gi[1], bi[1]).

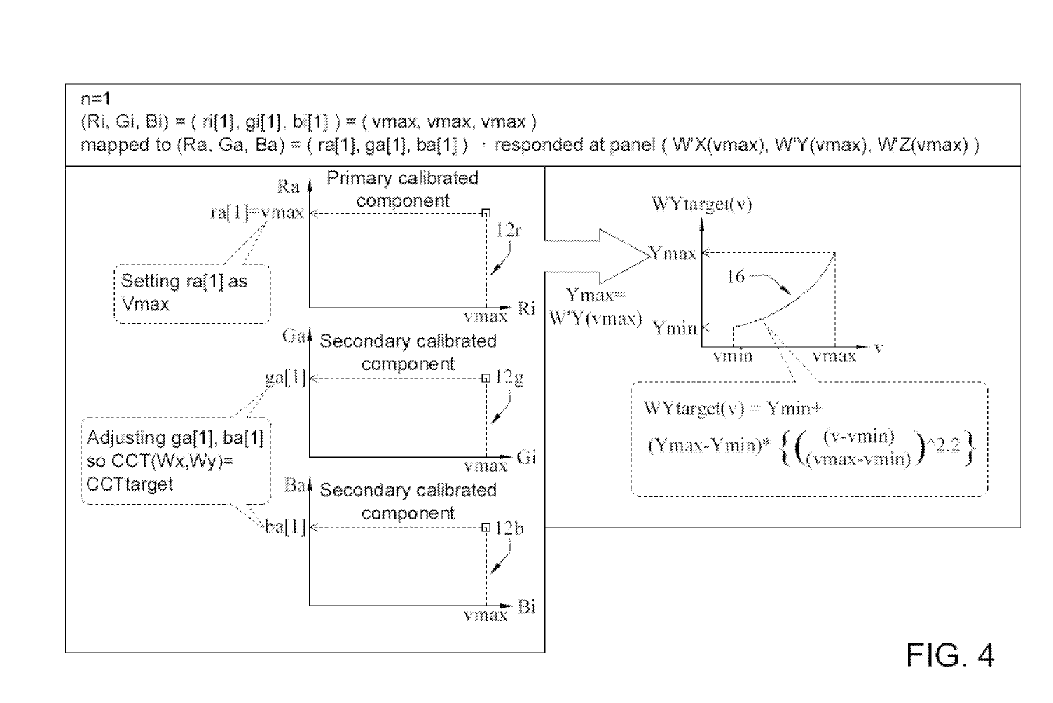

In Step 116, a reference curve is provided according to the top luma Ymax and the formula WYtarget(V)=Ymax*(V/Vmax)̂2.2, so as to associate the value V of a single source component of the grayscale input (Ri, Gi, Bi)=(V, V, V) to a corresponding target luma WYtarget(V). The reference curve associates the maximum value Vmax to the top luma Ymax. More generally, the reference curve may be represented as WYtarget(V)=Ymin+(Ymax−Ymin)*{((V−Vmin)/(Vmax−Vmin))̂2.2}, where Ymin is a constant. Since the constant Ymin and the minimum value Vmin may equal to 0, the reference curve may be simplified as WYtarget(V)=Ymax((V/Vmax)̂0.2. FIG. 4 illustrates Steps 108 and 116 with the primary calibrated component being the red component as an example, and a curve 16 is obtained from Step 116.

In Step 118, it is determined whether red, green and blue calibrated components ra[n], ga[n] and ba[n] corresponding to another set of red, green and blue source components ri[n], gi[n] and bi[n] (e.g., n=2 or n>2) are desired. Step 120 is performed if a result is affirmative, or else Step S136 is performed if the result is negative.

In Step 120, the value of the index n is updated to obtain the red, green and blue calibrated components ra[n], ga[n] and ba[n] corresponding the red, green and blue source components ri[n], gi[n] and bi[n]. The red, green and blue source components ri[n], gi[n] and bi[n] may equal the value V[n]. The value V[n] may be greater than or equaled to the minimum value Vmin but smaller than the maximum value Vmax.

In Step 122, the value V[n] is substituted into the reference curve 16 in Step S116, so as to obtain the target luma WYtarget(V[n]) corresponding to the value V[n] according to the reference curve 16.

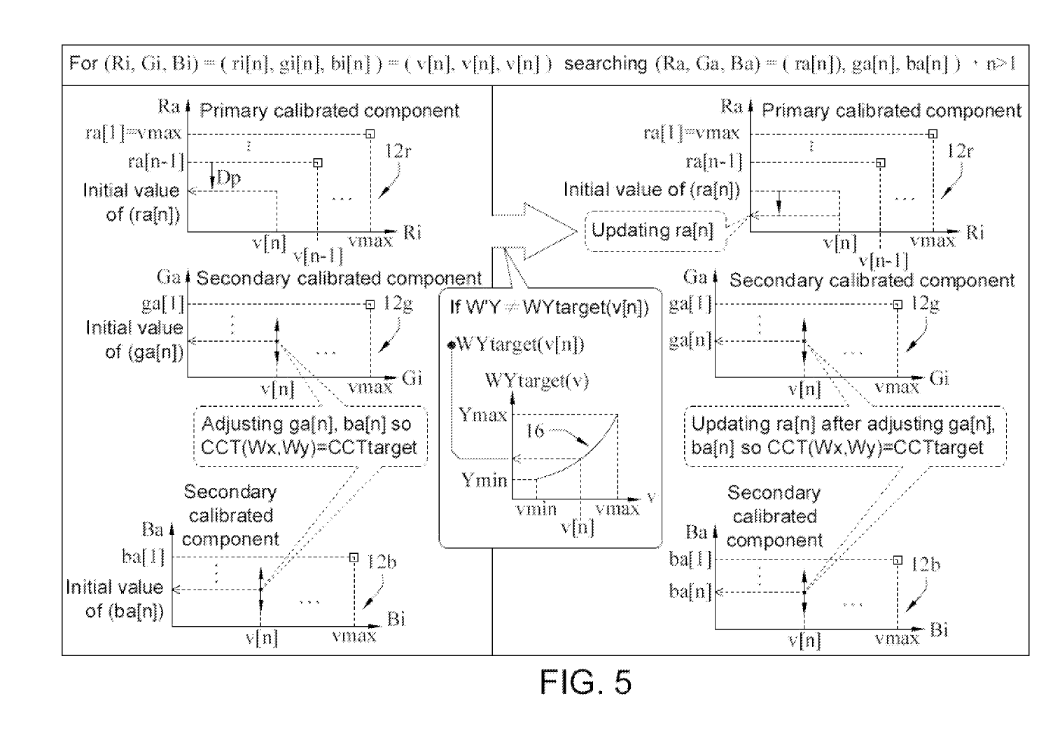

In Step 124, an initial value of the primary calibrated component is set. In an embodiment of the present disclosure, the initial value of a current cp[n] primary calibrated component may be set according to a previous primary calibrated component cp[n−1], wherein c is one of r, g and b. For example, the initial value of the primary calibrated component cp[n] may equal (cp[n−1]-Dp), where the value Dp represents a step level and may be a constant. In an embodiment, the value of the source components are 8-bit digital data, and the panel 14 supports 10-bit calibrated components. Therefore, the step level Dp may be Dp=(V[n]1)−V[n])/4. FIG. 5 illustrates Steps 122 and 124 with the primary calibrated component being the red component as an example.

In Step 126, similar to Step 110, the secondary calibrated components are set/adjusted. When Step 126 is performed following Step 124 and/or Step 132, initial values of the two secondary calibrated components are respectively set. When Step 126 is iterated following Step 128, the secondary calibrated components are adjusted under a condition that the primary calibrated component is remaining unchanged to further update the first input as the first updated input (Ru, Gu, Bu)=(ru[n], gu[n], bu[n]). For example, at least one of the two secondary calibrated components is increased or decreased, and the value decreased may equal the step level Dp or several times of Dp.

In Step 128, similar to Step 112, the corresponding color characteristic value CCT(Wx, Wy) is calculated from the first updated value obtained from Step 126. It is determined whether a relationship between the color characteristic value CCT(Wx, Wy) and the target characteristic value CCTtarget satisfies the first predetermined condition. Step 130 is performed when the first predetermined condition is satisfied, or else the process 100 iterates Step 126.

Step 130 is a luma comparison. In Step 130, for the first updated value (Ru, Gu, Bu)=(ru[n], gu[n], bu[n]) obtained from Step 126, corresponding white display value (W′X, W′Y, W′Z) and white luma W′Y are obtained. It is compared and determined whether a relationship between the white luma W′Y and the target luma WYtarget(V[n]) in Step 122 satisfies a second predetermined condition (e.g., a difference between the two is smaller than a second predetermined value). The process 100 performs Step 132 when the second predetermined condition is not satisfied, or else the process 100 performs Step 134.

In Step 132, the primary calibrated component is adjusted according to the first updated value (Ru, Gu, Bu)=(ru[n], gu[n], bu[n]) obtained in Step 130. For example, the primary calibrated component is decreased by one step level Dp. The process 100 may then iterate Step 126, in which the current first update value serves as the first input. With the primary calibrated component remaining unchanged, the color characteristic value fitting of Steps 126 and 128 is again performed. Assuming the primary calibrated component is the red component, FIG. 5 illustrates Steps 130 and 132 performed following Step 128.

Step 134 is reached after performing Steps 126, 128, 130 and/or 132 once or iterating Steps 126, 128, 130 and/or 132 for a number of times. That is to say, the luma WY and the target characteristic value CCT(Wx, Wy) responded according the first update value (Ru, Gu, Bu)=(ru[n], gu[n], bu[n]) at the panel 14 respectively match the target luma WYtarget(V[n]) and the target characteristic value CCTtarget at this point. Thus, the current first update value is taken as the calibrated input (Ra, Ga, Ba)=(ra[n], ga[n], ba[n]), which respectively provides corresponding red, green and blue calibrated components ra[n], ga[n] and ba[n] for the red, green and blue source components ri[n]=V[n], Gi[n]=V[n] and bi[n]=V[n] in the mapping tables 12r, 12g and 12b. The process 100 then proceeds to Step 118.

In Step 136, the process 100 ends. Accordingly, for the red, green and blue source components ri[n]=V[n], gi[n]=V[n] and bi[n]=V[n], n=1 to N, the corresponding red, green and blue calibrated components ra[n], ga[n] and ba[n] are provided. Furthermore, the luma WY and the color characteristic value CCT(Wx, Wy) responded by the panel 14 from the calibrated input (Ra, Ga, Ba)=(ra[n], ga[n], ba[n]), synthesized from the calibrated components, respectively match the target luma WYtarget(V[n]) and the target characteristic value CCTtarget. Therefore, the panel color calibration of the present disclosure achieves both luma tracking and color (color temperature) tracking.

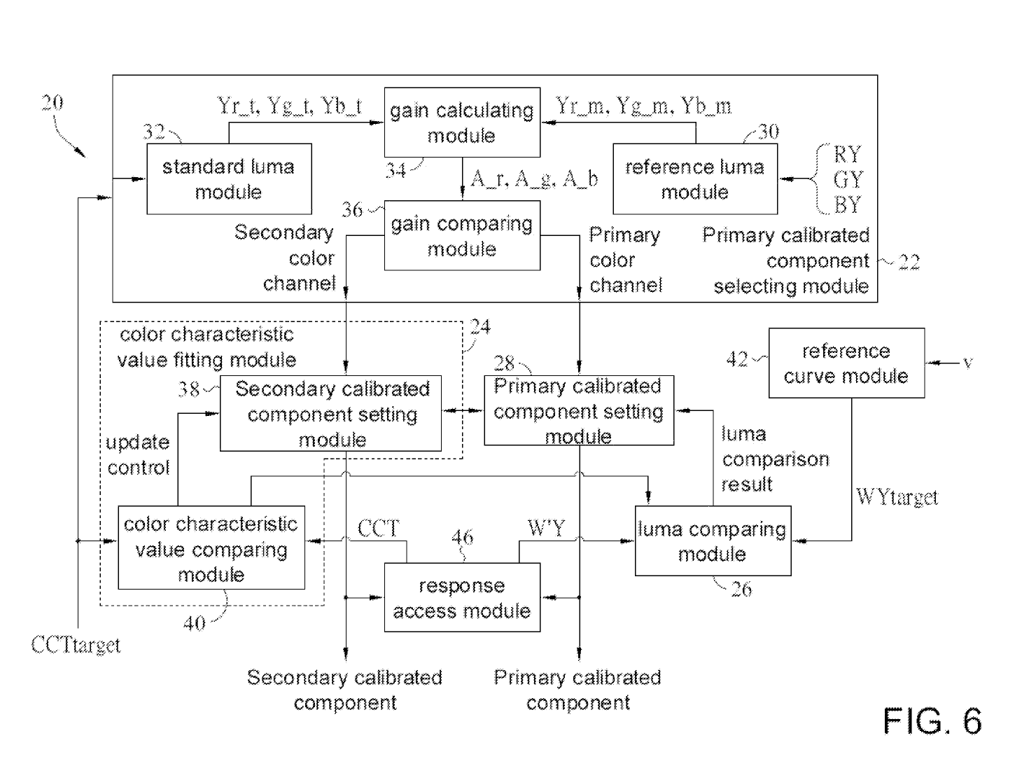

FIG. 6 shows a color calibration system 20 according to an embodiment of the present disclosure for realizing the above process 100. The color calibration system 20 is applied to the panel 14 in FIG. 1 to provide the calibrated input (Ra, Ga, Ba) corresponding to the source input (Ri, Gi, Bi) of the panel as well as the mapping tables 12r, 12g, and 12b for the controller 12. The color calibration system 20 comprises a primary calibrated component selecting module 22, a color characteristic value fitting module 24, a luma comparing module 26, a primary calibrated component setting module 28, a reference curve module 42, and a response access module 46. In an embodiment, the primary calibrated component selecting module 22 comprises a reference luma module 30, a standard luma module 32, a gain calculating module 34, and a gain comparing module 36. The color characteristic value fitting module 24 comprises a secondary calibrated component setting module 38 and a color characteristic value comparing module 40.

In the color calibration system 20, from three first input components of red, green and blue first input components, the primary calibrated component selecting module 22 selects one first input component as a primary calibrated component (as in Step 106), while the other two first input components are regarded as the secondary calibrated components. The reference luma module 30, being coupled to the gain calculating module 34, finds out the largest monochromatic lumas of respective colors of the panel 14 as red, green and blue reference monochromatic lumas Yr_m, Yg_m and Yb_m. The standard luma module 32, also being coupled to the gain calculating module 34, obtains the red, green and blue standard monochromatic lumas Yr_t, Yg_t and Yb_t according to the target characteristic value CCTtarget.

The gain comparing module 36 compares the standard monochromatic luma and the reference monochromatic luma of each of the first input components, and selects the primary calibrated component accordingly. In an embodiment, the gain calculating module 34, being coupled between the standard luma module 32, the reference luma module 30 and the gain comparing module 36, divides the reference monochromatic Yc_m by the standard monochromatic luma Yc_t to obtain the gain A_c, where c represents one of r, g and b. The gain comparing module 36, being coupled between the gain calculating module 34, the primary calibrated component setting module 28 and the secondary calibrated component setting module 38, compares the red, green and blue gains A_r, A_g and A_b to select the calibrated component corresponding to the smallest gain as the primary calibrated component.

The color characteristic value fitting module 24, being coupled to the primary calibrated component selecting module 22, performs a color characteristic value fitting. In the color characteristic value fitting, the primary calibrated component of the calibrated input remains unchanged, and the secondary calibrated components are adjusted to update the first input to serve as a first updated value, such that the relationship between the color characteristic value CCT corresponding to the first updated value and the target characteristic value CCTtarget satisfies the first predetermined condition.

The luma comparing module 26, being coupled to the color characteristic value fitting module 24, performs a luma comparison to compare and determine whether the relationship between the luma WY corresponding to the first updated value obtained from the color characteristic value fitting and the target WYtarget matches the second predetermined condition to provide a corresponding luma comparison result.

The primary calibrated component setting module 28 is coupled between the luma comparing module 26, the secondary calibrated component setting module 38 and the gain comparing module 36. After the primary calibrated component is selected by the primary calibrated component selecting module 22, the primary calibrated component setting module 28 sets and/or adjusts the primary calibrated component (as in Steps 108, 124 and 132). When a result from the luma comparison is negative, the primary calibrated component setting module 28 updates the primary calibrated component of the first updated value, and takes the current first updated value as the first input. The color characteristic value fitting module 24 and the luma comparing module 26 then respectively iterates the color characteristic value fitting and the luma comparison.

In the color characteristic value fitting module 24, the secondary calibrated component setting module 38 is coupled between the gain comparing module 36, the primary calibrated component setting module 28 and the color characteristic value comparing module 40. After the primary calibrated component is selected by the primary calibrated component selecting module 22, the secondary calibrated component setting module 38 sets and/or updates the secondary calibrated components with the primary calibrated component being unchanged (as in Steps 110 and 126). The first updated value is synthesized from the primary calibrated component and the secondary calibrated components. The response access module 46, being coupled to the primary calibrated component setting module 28 and the secondary calibrated component setting module 38, provides the display value (and the display components), the monochromatic lumas RY, GY and BY, the luma WY and the color characteristic value CCT responded at the panel 14 according to the first updated value (as shown by the equations in FIG. 1).

The color characteristic comparing module 40, being coupled between the luma comparing module 26 and the secondary calibrated component setting module 38, compares the color characteristic value CCT and the target characteristic value CCTtarget. When the relationship between the two satisfies the first predetermined condition, the luma comparing module 26 (as in Step 128) continues with luma comparison (as in Step 130). Conversely, when the relationship between the two does not satisfy the first predetermined condition, the secondary calibrated component setting module 38 again updates secondary calibrated components (as in Step 126) under update control.

The primary calibrated component setting module 28 further provides a top calibrated input (now shown), and renders the primary calibrated component in the top calibrated input to equal the maximum value Vmax (as in Step 108). The color characteristic value fitting module 24 further performs the color characteristic value fitting on the top calibrated input (as in Steps 110 and 112), so that the color characteristic value CCT responded at the panel 14 according to the top calibrated input matches the target characteristic value CCTtarget and the luma responded at the panel 14 is the top luma Ymax. The reference curve module 42, being coupled to the luma comparing module 26, provides the reference curve 16 (in FIGS. 4 and 5) according to the top luma Ymax, so as to associate the value V of a single source component of the grayscale input (Ri, Gi, Bi)=(V, V, V) to the corresponding target luma CCTtarget(V) as well as to associate the maximum value Vmax to the top luma Ymax by the reference curve. When the luma comparison is performed by the luma comparing module 26 (as in Step 128), the reference curve module 42 determines the target luma CCTtarget(V) according to the value V of the source component and the reference curve.

The color calibration system 20 may be realized by software, firmware, and/or hardware. For example, the color calibration system 20 can be implemented in a computer, which is provided with a processor and a memory device (e.g., a volatile or non-volatile memory device) for storing various codes. Functions of the primary calibrated component selecting module 22, the color characteristic value fitting module 24, the luma comparing module 26, the primary calibrated component setting module 28, and the response access module 46 are respectively implemented as the codes executed by the processor.

In conclusion, compared to conventional techniques, the panel calibration technique of the present disclosure is capable of fulfilling targets of both luma and color characteristic values, such that luma tracking and color (color temperature) tracking can both be achieved to fully compensate response differences between different panels, thereby rendering consistent color display for different panels.

While the present disclosure has been described by way of example and in terms of the preferred embodiments, it is to be understood that the present disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for color calibration of a panel to provide a calibrated input corresponding to a first input of the panel that comprises a plurality of first input components, the method comprising:
selecting one of the first input components as a primary calibrated component and other ones of the first input components as a plurality of secondary calibrated components;
performing a color characteristic value fitting on the first input to generate a first updated value such that a relationship between a target characteristic value and a color characteristic value corresponding to the first updated value satisfies a first predetermined condition;
performing a luma comparison, comprising determining whether a relationship between a target luma and a luma corresponding to the first updated value satisfies a second predetermined condition, to generate a luma comparison result; and
providing the first updated value as the calibrated input when the luma comparison result is affirmative.

2. The method according to claim 1, further comprising:
responsive to the luma comparison result being negative, updating the primary calibrated component of the first updated value, utilizing an updated first updated value as the primary calibrated component in the first input, and iterating the color characteristic value fitting and the luma comparison.

3. The method according to claim 2, wherein the color characteristic value fitting comprises:
maintaining the primary calibrated component; and
adjusting the secondary calibrated components to generate the first updated value.

4. The method according to claim 2, wherein the panel respectively responds a plurality of monochromatic inputs to a plurality of monochromatic lumas, wherein each of the monochromatic inputs corresponds to one of the first input components; and wherein the selecting one of the first input components as the primary calibrated component comprises:
selecting one of the monochromatic lumas, corresponding to a same first input component, as a reference monochromatic luma corresponding to the first input component;
obtaining a standard monochromatic luma for each of the first input components according to the target characteristic value; and
selecting the primary calibrated component according to the standard monochromatic luma and the reference monochromatic luma corresponding to each of the first input components.

5. The method according to claim 4, wherein the selecting the primary calibrated component according to the standard monochromatic luma and the reference monochromatic luma corresponding to each of the first input components comprises:
dividing the reference monochromatic luma by the standard monochromatic luma corresponding to each of the first input components to obtain a respective gain corresponding to each of the first input components; and
selecting one of the first input components with a smallest gain of the gains as the primary calibrated component.

6. The method according to claim 4, wherein the selecting one of the monochromatic lumas as the reference monochromatic luma corresponding to each of the first input components comprises selecting a largest monochromatic luma of the monochromatic lumas as the reference monochromatic luma.

7. The method according to claim 1, wherein a respective value of each of the first input components in the first input is between a minimum value and a maximum value, and wherein the method further comprises:
rendering the primary calibrated component in the first input equal to the maximum value; and
performing the color characteristic value fitting to obtain a top calibrated input.

8. The method according to claim 7, wherein the panel responds the top calibrated input as a top luma, wherein the source input comprises a plurality of source components, and wherein the method further comprises:
providing a reference curve according to the top luma in a way that the reference curve associates a value of each of the source components to a corresponding target luma, and further associates the maximum value to the top luma,
wherein the luma comparison comprises determining the target luma according to the value of the respective source component and the reference curve.

9. The method according to claim 1, wherein the color characteristic value is a color temperature, and the target characteristic value is a target color temperature.

10. A color calibration system applied to a panel to provide a calibrated input corresponding to a first input of the panel that comprises a plurality of first input components, the color calibration system comprising:
a primary calibrated component selecting module that selects one of the first input components as a primary calibrated component, and other ones of the first input components as a plurality of secondary calibrated components;
a color characteristic value fitting module, coupled to the primary calibrated component selecting module, that performs a color characteristic value fitting to generate a first updated value such that a relationship between a target characteristic value and a color characteristic value corresponding to the first updated value satisfies a first predetermined condition; and
a luma comparison module, coupled to the color characteristic value fitting module, that determines whether a relationship between a target luma and a luma corresponding to the first updated value satisfies a second predetermined condition to generate a luma comparison result, and that utilizes the first updated value as the calibrated input when the luma comparison result is affirmative.

11. The color calibration system according to claim 10, further comprising:
a primary calibrated component setting module, coupled to the luma comparison module, that updates the primary calibrated component in the first updated value when the luma comparison result is negative, and that utilizes an updated first updated value as the primary calibrated component for the color characteristic value fitting module and the luma comparing module to respectively iterate the color characteristic value fitting and update the luma comparison result.

12. The color calibration system according to claim 11, wherein the color characteristic value fitting module performs the color characteristic value fitting by:
maintaining the primary calibrated component; and
adjusting the secondary calibrated components to generate the first updated value.

13. The color calibration system according to claim 11, wherein the panel respectively responds a plurality of monochromatic inputs to a plurality of monochromatic lumas, wherein each of the monochromatic inputs corresponds to one of the first input components, and wherein the primary calibrated component selecting module comprises:
a reference luma module, that selects one of the monochromatic lumas, corresponding to a same first input component, as a reference monochromatic luma corresponding to the first input component;
a standard luma module, that obtains a standard monochromatic luma for each of the first input components according to the target characteristic value; and
a gain comparing module, coupled to the standard luma module and the reference luma module, that selects the primary calibrated component according to the standard monochromatic luma and the reference monochromatic luma corresponding to each of the first input components.

14. The color calibration system according to claim 13, wherein the primary calibrated component selecting module further comprises:
a gain calculating module, coupled between the standard luma module, the reference luma module and the gain comparing module, that divides the reference monochromatic luma by the standard monochromatic luma corresponding to each of the first input components to obtain a respective gain corresponding to each of the first input components, compares the gains corresponding to the first input components, and selects one of the first input components with a smallest gain of the gains as the primary calibrated component.

15. The color calibration system according to claim 13, wherein the reference luma module selects a largest monochromatic luma of the monochromatic lumas as the reference monochromatic luma.

16. The color calibration system according to claim 10, wherein a respective value of each of the first input components in the first input is between a minimum value and a maximum value, wherein the primary calibrated component setting module furthers renders the primary calibrated component in the first input equal to the maximum value, and further performs the color characteristic value fitting to provide a top calibrated input.

17. The color calibration system according to claim 16, wherein the panel responds the top calibrated input as a top luma, wherein the source input comprises a plurality of source components, and wherein the color calibration system further comprises:
a reference curve module, coupled to the luma comparing module, that provides a reference curve according to the top luma to in a way that the reference curve associates a value of each of the source components to the corresponding target luma, and further associates the maximum value to the top luma; and
determining the target luma according to the value of the respective source component and the reference curve.

18. The color calibration system according to claim 10, wherein the color characteristic value is a color temperature, and the target characteristic value is a target color temperature.
